(19) United States
(12) Patent Application Publication
(10) Pub. No.: US 2021/0027634 A1
(43) Pub. Date: Jan. 28, 2021

(54) ROUTE PLANNING METHOD AND DEVICE

(71) Applicant: SZ DJI TECHNOLOGY CO., LTD., Shenzhen (CN)

(72) Inventor: Jinsong LI, Shenzhen (CN)

(21) Appl. No.: 17/035,335

(22) Filed: Sep. 28, 2020

Related U.S. Application Data
(63) Continuation of application No. PCT/CN2018/081460, filed on Mar. 30, 2018.

(51) Int. Cl. G08G 5/00; B64C 39/02

(52) U.S. Cl. CPC G08G 5/006; G08G 5/0034; B64C 2201/14; B64C 39/024; B64C 2201/12; G08G 5/0069

(57) ABSTRACT

A route planning method includes obtaining a work region and operation points of the work region, dividing the work region into a plurality of operation regions, obtaining ports of the plurality of operation regions, and imposing one or more constraint conditions on waypoints of the work region to obtain a minimized no-operation route. The waypoints include the operation points and the ports.

### CROSS-REFERENCE TO RELATED APPLICATION

This application is a continuation of International Application No. PCT/CN2018/081460, filed on Mar. 30, 2018, the entire content of which is incorporated herein by reference.

### TECHNICAL FIELD

The present disclosure relates to the technical field of operation carrier and, more particularly, to a route planning method and device for operation carrier.

### BACKGROUND

An operation carrier includes an unmanned aerial vehicle (UAV), an unmanned vehicle, or another device, which is widely used in agricultural, forestry and plant protection operations such as spraying, fertilization, irrigation, and the like, sweeping, demining, search and rescue, and other operations that require a route planning.

When the operation carrier is performing an operation, a work region of the operation carrier is generally divided into a plurality of operation regions according to a shape of the work region, whether there are obstacles in the work region, and other factors. An operation route is planned in one of the plurality of operation regions and the operation carrier is performing the operation along the operation route. After finishing the operation in one of the plurality of operation regions, the operation carrier moves to a next operation region to continue the operation. The operation is not performed when the operation carrier is moving between different operation regions, and a route of the operation carrier moving between different operation regions is a no-operation route. The conventional route planning does not consider the no-operation route. An excessively long no-operation route increases a moving time and mileage of the operating carrier, wastes an energy of the operating carrier, and reduces an operation efficiency of the operating carrier.

### SUMMARY

In accordance with the disclosure, there is provided a route planning method including obtaining a work region and operation points of the work region, dividing the work region into a plurality of operation regions, obtaining ports of the plurality of operation regions, and imposing one or more constraint conditions on waypoints of the work region to obtain a minimized no-operation route. The waypoints include the operation points and the ports.

Also in accordance with the disclosure, there is provided a route planning device including a memory storing executable instructions, and a processor configured to execute the executable instructions stored in the memory to obtain a work region and operation points of the work region, divide the work region into a plurality of operation regions, obtain ports of the plurality of operation regions, and impose one or more constraint conditions on waypoints of the work region to obtain a minimized no-operation route. The waypoints include the operation points and the ports.

Also in accordance with the disclosure, there is provided an operation carrier including a route planning device. The route planning device includes a memory storing executable instructions, and a processor configured to execute the executable instructions stored in the memory to obtain a work region and operation points of the work region, divide the work region into a plurality of operation regions, obtain ports of the plurality of operation regions, and impose one or more constraint conditions on waypoints of the work region to obtain a minimized no-operation route. The waypoints include the operation points and the ports.

### BRIEF DESCRIPTION OF THE DRAWINGS

The accompanying drawings being a part of the specification are intended to provide a further understanding of the present disclosure. The example embodiments will be described with reference to the accompanying drawings to illustrate the present disclosure and are not intended to limit the present disclosure.

FIG. 1A shows a work region divided into a plurality of operation regions consistent with embodiments of the disclosure.

FIG. 1B shows an example operation region \textcircled{1} of the work region consistent with embodiments of the disclosure.

FIG. 2A takes an operation region having six routes as an example to show a relationship between an entrance and exit of the operation region consistent with embodiments of the disclosure.

FIG. 2B takes an operation region having five routes as an example to show a relationship between an entrance and exit of the operation region consistent with embodiments of the disclosure.

FIG. 3 shows a no-operation route consistent with embodiments of the disclosure.

FIG. 4 is a schematic flow chart of a route planning method consistent with embodiments of the disclosure.

FIGS. 5A and 5B schematically show route planning results consistent with embodiments of the disclosure.

FIG. 6 is a schematic diagram of a route planning device consistent with embodiments of the disclosure.

FIG. 7 is a schematic diagram of computer readable storage medium consistent with embodiments of the disclosure.

### DETAILED DESCRIPTION OF THE EMBODIMENTS

The present disclosure provides a route planning method applicable to various autonomous operation carriers. For simplifying of description, the present disclosure takes an unmanned aerial vehicle (UAV) as an example, but the route planning method can be applicable to all kinds of operation carriers, e.g., vehicles, ships, robots, and the like.

In order to provide a clearer illustration of objectives, technical solutions, and advantages of present disclosure, example embodiments will be described with reference to the accompanying drawings.

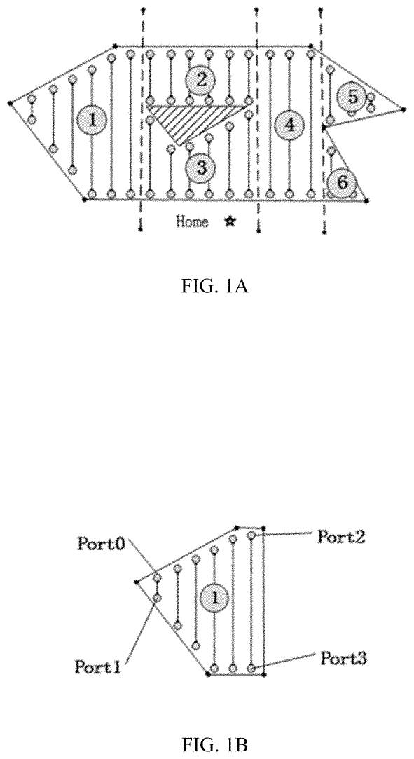

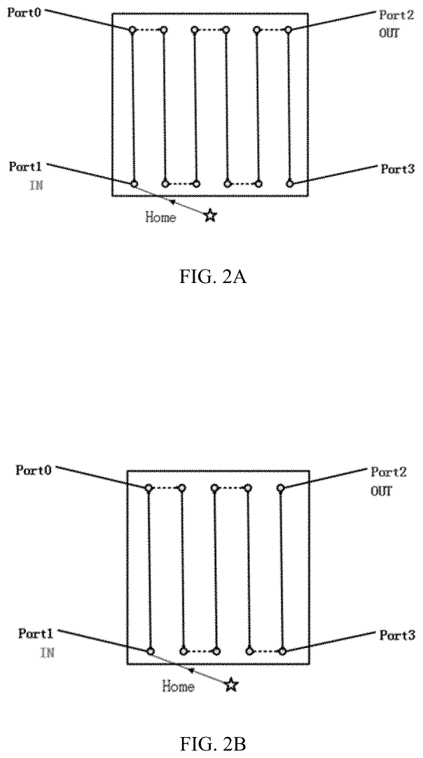

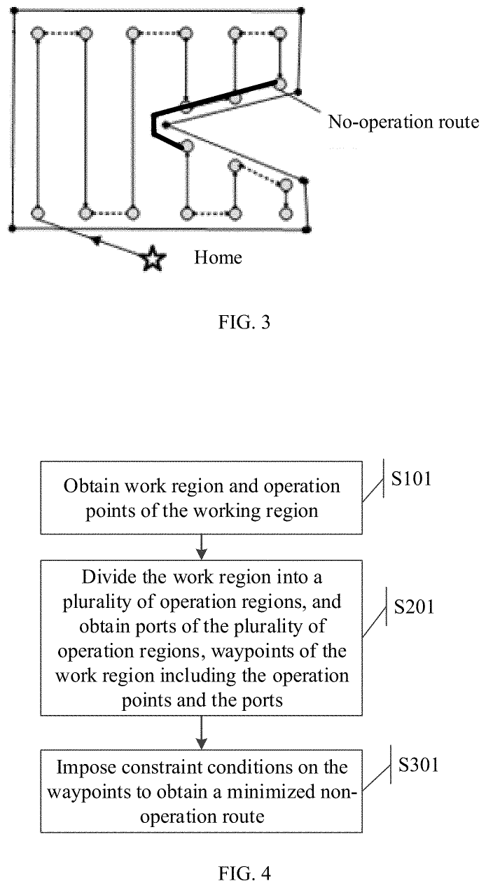

FIG. 1A shows an example work region divided into a plurality of operation regions denoted by \textcircled{1} to \textcircled{6} consistent the disclosure. FIG. 1B shows an example operation region \textcircled{1} of the work region consistent with the disclosure. FIG. 2A takes the operation region having six routes as an example to show a relationship between an entrance and exit of the operation region consistent with the disclosure. FIG. 2B takes the operation region having six routes as an example to show the relationship between the entrance and exit of the operation region consistent with the disclosure. FIG. 3 shows an example no-operation route consistent with the disclosure. FIG. 4 is a schematic flow chart of an example route planning method consistent with embodiments of the disclosure.

As shown in FIG. 4, at S101, the work region and operation points of the work region are obtained. The work region can refer to an entire region where the UAV can perform an operation. The work region of the UAV can be obtained by obtaining position information of a boundary of the work region, and the position information may include coordinate values of the boundary. For example, the coordinate values of the boundary may be input by a user, or the coordinate values of the boundary may be obtained by performing image recognition on an image of the work region.

The operation points of the work region can refer to a type of points passed through by the UAV during the operation and including an origin point, a start point, an end point, a relay point, and the like. The origin point can at least refer to a point where the UAV takes off and returns to after completing the operation in the work region. The start point can refer to a take-off point of the UAV, and the end point can refer to a recycle point where the UAV returns to after taking off from the start point and completing the operation in the work region. The relay point can at least refer to a point to which the UAV temporarily returns for maintenance when some conditions (e.g., failure, insufficient power, insufficient medicine, and the like) occur during the operation of the UAV, or a point at which the UAV stops working according to different times.

At S201, the work region is divided into the plurality of operation regions, and ports of the plurality of operation regions are obtained. Waypoints of the work region include the operation points and the ports. After the work region is obtained, the work region can be divided into a plurality of sub-regions according to operation characteristics of the UAV including, for example, fewer turns, flying nearby, traversing the work region, and the like, especially when the work region is a concave polygon , or when there are obstacles in the work region. The sub-region can be also referred to as the operation region. As shown in FIG. 1A, the work region is divided into 6 operation regions denoted by \textcircled{1}, \textcircled{2}, \textcircled{3}, \textcircled{4}, \textcircled{5} and \textcircled{6}, a shaded area represents the obstacle, and “Home ⋆” represents the origin point of the UAV. FIG. 1B shows the operation region \textcircled{1}.

The obstacles in the work region can refer to regions having obstacles that the UAV needs to circumvent, such as houses, telegraph poles, and other objects that the UAV cannot fly over. When there are the obstacles in the work region, the coordinate values of the boundary of the obstacles are obtained to divide the work region into the plurality of operation regions.

In some embodiments, a plurality of route segments parallel to each other in the work region can be firstly obtained, and the plurality of operation regions can be then obtained according to directions of the route segments and the position information of the boundary of the work region. The division methods for the work region are not limited herein, and other methods may be used to divide the work region, such as using the position information of the boundary of the work region and working widths of the operation carrier.

Each route segment has two endpoints, and a route between the endpoints of two adjacent route segments is a traverse route of the UAV perpendicular to the directions of the route segments. The route segments and the traverse routes in the operation region can form the operation route of the UAV in the operation region. The directions of the route segments can be generally related to a flight direction of the UAV. In some embodiments, the directions of the route segments can be parallel to the flight direction of the UAV. The flight direction of the UAV can be related to many factors, such as a relative position of the origin point of the UAV and the work region, a wind direction of the work region, and the like. In some embodiments, a direction of a longest side of the work region can be used as the flight direction of the UAV.

The division methods for the work region described above are not intended to limit the present disclosure, and any other division method may be used for dividing the work region.

For the plurality of route segments in the operation region, the endpoints of two outermost route segments can be used as the ports of the operation region. For example, as shown in FIG. 1B, the endpoints of the leftmost and rightmost route segments are the ports of the operation region \textcircled{1}, i.e., Port0, Port1, Port2, and Port3. That is, there are four ports for each operation region. Each of the four ports can be used as the entrance of the operation region or the exit of the operation region. For each flight operation of the UAV in the operation region, a role of each port (e.g., as an entrance or exit) can be fixed, which can be determined by the number of route segments in the operation region. For example, as shown in FIG. 2A, there are six route segments in the operation region. When Port1 is the entrance, the UAV will fly in from Port1. The UAV can fly over one route segment and then moves horizontally to the next route segment, fly over the next route segment and then moves to the route segment immediately after the next route segment, and so on so forth, and finally fly out of the operation region through Port3, i.e., Port3 is the exit. As another example, as shown in FIG. 2B, there are five route segments in the operation region. When Port1 is the entrance, the UAV will fly in from Port1. The UAV can fly over one route segment and then moves horizontally to the next route segment, fly over the next route segment and then moves to the route segment immediately after the next route segment, so on so forth, and finally fly out of the operation region through Port2, i.e., Port2 is the exit. For each operation region, a corresponding relationship between the entrance and exit can be determined by a parity of the number of route segments in the operation region. When the number of route segments is odd, the corresponding relationship can be Port0 as the entrance and Port3 as the exit, or Port1 as the entrance and Port2 as the exit, i.e., Port0 and Port3 can be paired, Port1 and Port2 can be paired. When the number of route segments is even, the corresponding relationship can be Port0 as the entrance and Port2 as the exit, or Port1 as the entrance and Port3 as the exit, i.e., Port0 and Port2 can be paired, Port1 and Port3 can be paired. In this disclosure, two ports of an operation region being paired refers to one of the two ports being used as an entrance of the operation region and the other one of the two ports being used as an exit of the operation region.

The methods described above are merely examples of obtaining the ports of the operation region, but are not intended to limit the present disclosure. In some embodiments, the work region may not include the plurality of route segments parallel with each other, but other kinds of route segments. The ports of the operation region can be selected according to the kinds of the route segments.

The ports and the operation points can be collectively referred to as the waypoints of the work region. The UAV may perform the operation only on the operation route but does not perform the operation when flying between waypoints. That is, the UAV does not perform the operation when transferring between various operation regions. The route between the waypoints can form the no-operation route of the UAV. That is, the no-operation route may go through at least one operation point and the ports of at least one operation region. In some embodiments, the no-operation route may go through some operation points and the ports of all operation regions. For example, if the UAV needs to perform the operation in the entire work region and does not need to be maintained or temporarily grounded during the entire operation process, then the UAV only needs to pass through the origin point and ports of all operation regions, and does not need to pass through any relay point. In some embodiments, the no-operation route can go through some operation points and the ports of some operation regions. For example, if the UAV only needs to perform the operation on some of the plurality of operation regions, and does not need to be maintained and temporarily grounded during the entire operation process, then the UAV only needs to pass through the origin point and the ports of some operation regions, and does not need to pass through any relay point. In some embodiments, the no-operation route can go through all operation points and ports of some operation regions. For example, if the UAV only needs to perform the operation in some of the plurality of operation regions, and needs to be maintained or temporarily grounded during the entire operation process, then the UAV needs to pass through the origin point, some or all relay points, and the ports of some operation regions. In some embodiments, the no-operation route can go through all operation points and the ports of all operation regions. For example, if the UAV needs to perform the operation in all of the plurality of operation regions, and needs to be maintained or temporarily grounded during the entire operation process, then the UAV needs to pass through the origin point, some or all relay points, and the ports in all operation regions.

As shown in FIG. 3, the no-operation route is denoted by the bold line. The no-operation route needs to be minimized to improve an operation efficiency and reduce an unnecessary flight time and power consumption.

Referring again to FIG. 4, at S301, constraint conditions are imposed on the waypoints to obtain a minimized no-operation route passing through at least one operation point and the ports of at least one operation region. The objective is to obtain the minimized no-operation route. That is, a length of the no-operation route passing through the operation point and the ports of at least one operation region is the smallest. Therefore, in some embodiments, the minimized no-operation route can be used as a constraint condition.

An undirected graph G can be established with connection lines between the waypoints as edges. The mathematical expression of the constraint condition can be an objective function as follows:

$$minimize {\sum }_{( i , j ) ∈ E} {d}_{ij} \cdot {x}_{ij}$$

$${x}_{ij} ∈ \{ 0 , 1 \}$$

where E represents a set of edges in the undirected graph G, xᵢⱼ represents whether there is a connection line between waypoint i and waypoint j, dᵢⱼ represents a length of the connection line between waypoint i and waypoint j, which may reflect the distance between waypoint i and waypoint j.

For the objective function, xᵢⱼ represents whether the route between waypoints i and j is selected. When the route is selected, the value of xᵢⱼ corresponding to the route can be set as 1, and when the route is not selected, the value of xᵢⱼ corresponding to the route can be set as 0. dᵢⱼ represents the length of the route between the waypoints i and j.

In some embodiments, each operation region may satisfy the following condition to obtain the minimized no-operation route. That is, the routes can only be formed between two ports of the operation region and other waypoints, and only one route can be formed between each port and the other waypoints. The other waypoints can include the operation points and the ports of other operation regions adjacent to the operation region. The condition described here can be used as another constraint condition.

The mathematical expression of this constraint condition can be as follows:

$${\sum }_{i ∈ {V}_{R} , j ∈ {V}_{R ′}} {x}_{ij} = 2$$

where R represents the operation region, R′ represents all operation regions adjacent to the operation region R, and V_{R} represents a set of ports in R, V_{R′} represents a set of ports in R′.

This constraint condition indicates that a sum of degrees of the ports in the operation region is 2. V_{R} corresponds to the ports in the operation region R, and V_{R′} corresponds to the ports of all operation regions R′ adjacent to the operation region R.

In some embodiments, each operation region may satisfy the following condition to minimize the no-operation route. That is, the two ports paired with each other in the operation region can form equal number of routes with the other waypoints. The other waypoints can include the operation points and the ports of other operation regions adjacent to the operation region.

The mathematical expression of this constraint condition can be as follows:

$${\sum }_{j ∈ {V}_{{R}^{′}}} {x}_{aj} = {\sum }_{j ∈ {V}_{{R}^{′}}} {x}_{bj}$$

where ∀ₐ∈Vₐ, ∀_{b}∈V_{b}, Vₐ represents a first port set in R, V_{b} represents a second port set in R, and the ports in the first port set can be paired with the ports in the second port set. For example, referring again to FIG. 2A, the first port set includes Port0 and Port1 and the second port set includes Port2 and Port3. Port0 and Port2 can be paired ports, and Port1 and Port3 can be paired ports. The constraint condition indicates that the degrees of the paired ports in the operation region can be equal.

In some embodiments, the operation points may satisfy the following condition to obtain the minimized no-operation route. That is, when the operation points only includes the origin point, there are two routes between the origin point and the ports of the at least one operation region, and when the operation points includes the start point and the end point, there is one route between the start point and the ports of the at least one operation region and one route between the end point and the ports of the at least one operation region. The condition described herein can be used as another constraint condition.

The mathematical expression of this constraint condition can be as follows:

Σ_{j∈V} xᵢⱼ=2

where i represents the origin point, V represents a set of waypoints in the undirected graph G, and the mathematical expression indicates a degree of the origin point of the UAV can be 2.

$${\sum }_{j ∈ V} {x}_{ij} = 1$$

where i represents the origin point or the end point, V represents the set of waypoints in the undirected graph G, and the mathematical expression indicates both the degree of the start point and the degree of the end point of the UAV can be 1.

In some embodiments, when the operation points further include the relay point, the operation points may satisfy the following condition. There are two routes between the relay point and the other waypoints, and the other waypoints can include the ports of the operation region, the origin point, or the start point and end point, and other relay points. The mathematical expression can be as follows:

$${\sum }_{j ∈ V} {x}_{ij} = 2$$

where i represents the relay point, V represents the set of waypoints in the undirected graph G, and the mathematical expression indicates a degree of the relay point of the UAV can be 2.

Each of the four constraint conditions described above can be referred to as a first constraint condition, and the four first constraint conditions can be collectively referred to as a first set of constraint conditions.

In some embodiments, the waypoints may satisfy the following condition to obtain the minimized no-operation route. That is, some waypoints on the no-operation route cannot form sub-loops. The condition described herein can be used as another constraint condition referred to as a sub-loop constraint condition or a second constraint condition.

This constraint condition indicates that some waypoints on the no-operation route can only form an open route, but cannot be allowed to form a loop. Because if some waypoints form the sub-loops, the sub-loops can be isolated from each other, and the no-operation route cannot be minimized.

The mathematical expression of this constraint condition can be as follows:

$${\sum }_{i , j ∈ S} {x}_{ij} \leq \vert S \vert - 1 S ⊆ V ; S \neq ∅$$

where S represents any subset of V, ∅ denotes an empty set.

After the constraint conditions described above are obtained, the constraint conditions can be solved to obtain the minimized no-operation route. The processes can include the following. The no-operation route under the first set of constraint conditions can be solved. Whether the no-operation route satisfies the sub-loop constraint condition can be determined. If yes, the no-operation route can be determined as the minimized no-operation route. If not, the sub-loop constraint condition can be applied to the no-operation route to obtain a new no-operation route, the no-operation route can be replaced with the new no-operation route, and a process of determining whether the no-operation route satisfies the sub-loop constraint condition can be returned for being executed.

An integer linear programming (ILP) method can be used to solve the no-operation route, but the disclosure is not limited thereto, and any similar solution method can be used. Consistent with the disclosure, through obtaining the minimized no-operation route, a flight mileage and flight time of the UAV can be reduced, the power of the UAV can be saved, and the operation efficiency of the UAV can be improved. An execution entity of the route planning method described above may include the UAV or a controller of the UAV.

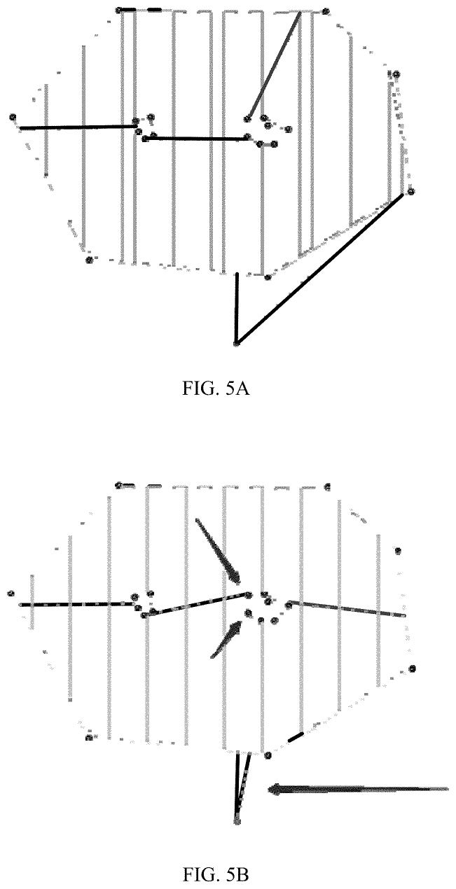

FIGS. 5A and 5B schematically show route planning results consistent with the disclosure. As shown in FIG. 5A, the entire work region is a polygon having two obstacles, and the operation point outside the work region represents the origin point of the UAV. The bold line represents the no-operation region between the operation regions planned according to a conventional method, the other lines represent the operation route, and the length of the entire operation route is 1846 meters. The route planning results obtained according to the route planning method consistent with the present disclosure is shown in FIG. 5B. The work region and the division of the work region are same in FIGS. 5A and 5B. As shown in FIG. 5B, when selecting the entrances and exits (e.g., an entrance and exit denoted by arrows in the middle of FIG. 5B), the exit of a left operation region is not connected to the entrance of an operation region closest to the exit. Instead, an entrance of an operation area that is a little farther away from the exit is selected. Since different entrances of the operation region correspond to different exits, the selection of the entrance will affect the next route selection. Using the no-operation route planned by the present disclosure, the length of the entire working route is 1549 meters, which is significantly reduced compared to the length obtained using the conventional method in FIG. 5A.

The types of operations are not limited herein and can include plant protection operations, sweeping, demining, search and rescue, and other operations requiring the route planning.

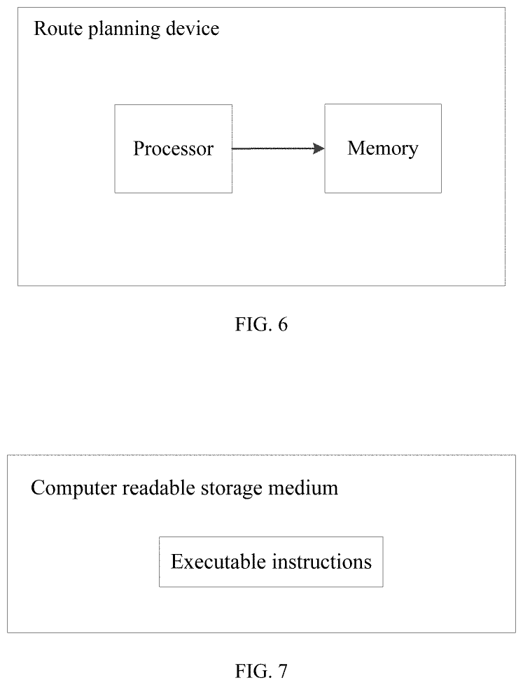

The present disclosure provides a route planning device. FIG. 6 is a schematic diagram of an example route planning device consistent with the disclosure. As shown in FIG. 6, the route planning device includes a memory storing executable instructions, and a processor configured to execute the executable instructions stored in the memory to perform the following operations.

The work region and the operation points of the work region can be obtained. The work region can be divided into the plurality of operation regions, and the ports of the plurality of operation regions can be obtained, and the waypoints of the work region can include the operation points and the ports. The constraint conditions can be imposed on the waypoints to obtain the minimized no-operation route.

In some embodiments, obtaining the work region can include obtaining the position information of the boundary of the work region to obtain the work region. Dividing the work region into the plurality of operation regions can include obtaining the plurality of route segments parallel to each other in the work region, and obtaining the plurality of operation regions according to the direction of the route segments and the position information of the boundary of the work region. Obtaining the ports of the plurality of operation regions can include using the endpoints of two outermost route segments as the ports of each operation region.

In some embodiments, the operation points of the work region can include the origin point. The constraint conditions can include the first set of constraint conditions and the second constraint condition. The first set of constraint conditions can include the length of the no-operation route passing through the original point and the ports of at least one operation region being the smallest, one route being formed between each port of two ports of the operation region and other waypoints, the two ports paired with each other in the operation region forming equal number of routes with the other waypoints, two routes formed between the origin point and the ports of the at least one operation region. The second constraint condition can include that some waypoints on the no-operation route cannot form the sub-loops.

In some embodiments, the operation points of the work region can include the start point and the end point. The constraint conditions can include the first set of constraint conditions and the second constraint condition. The first set of constraint conditions can include the length of the no-operation route passing through the start point, the end point, and the ports of at least one operation region being the smallest, one route being formed between each port of two ports of the operation region and the other waypoints, the two ports paired with each other in the operation region forming equal number of routes with the other waypoints, both the start point and the end point forming one route with the ports of the at least one operation region. The second constraint condition can include that some waypoints on the no-operation route cannot form the sub-loops.

In some embodiments, the operation points of the work region can further include the relay point. The first set of constraint conditions can further include two routes can be formed between the relay point and the other waypoints.

In the first set of constraint conditions, the other waypoints with respect to a current operation region can include the operation points and the ports of other operation region(s) adjacent to the current operation region.

In some embodiments, the two outermost route segments can be referred as a first route segment and a second route segment. When the number of route segments that are parallel to each other in the operation region is odd, the two ports on opposite sides of the first route segment and the second route segment can be paired. When the number of route segments that are parallel to each other in the operation region is even, the two ports on the same side of the first route segment and the second route segment can be paired.

In some embodiments, solving the minimized no-operation route under the constraint conditions (i.e., solving the objective functions to obtain the minimized no-operation route) can include the following. The no-operation route under the first set of constraint conditions can be solved. Whether the no-operation route satisfies the sub-loop constraint condition can be determined. If yes, the no-operation route can be determined as the minimized no-operation route. If not, the sub-loop constraint condition can be applied to the no-operation route to obtain a new no-operation route, the no-operation route can be replaced with the new no-operation route, and the process of determining whether the no-operation route satisfies the sub-loop constraint condition can be returned for being executed. The ILP method can be used to solve the no-operation route. A no-operation route being checked to determine whether it is the minimized no-operation route, e.g., as described above, is also referred to as a “candidate no-operation route.”

In some embodiments, the minimized no-operation route can pass through at least one operation point and the ports of at least one operation region.

FIG. 6 shows schematic block diagram of a hardware structure of the route planning device. The hardware structure includes the processor (e.g., a microprocessor, a digital signal processor, or the like). The processor may include a single processing unit or multiple processing units for performing different actions of the processes described herein.

The memory may include a non-volatile or volatile readable storage medium, such as an electrically erasable programmable read-only memory (EEPROM), a flash memory, and/or a hard drive. The readable storage medium can store a computer program, and the computer program can include codes or computer readable instructions. When the codes or computer readable instructions are executed by the processor, the hardware structure and/or the device including the hardware structure can execute, for example, the processes described in connection with FIG. 4 and any variations thereof.

The processor may include a single central processing unit (CPU), or two or more processing units. For example, the processor may include a general-purpose microprocessor, an instruction set processor and/or a related chipset and/or a special-purpose microprocessor, e.g., an application specific integrated circuit (ASIC).

Consistent with the disclosure, through obtaining the minimized no-operation route, the flight mileage and flight time of the UAV can be reduced, the power of the UAV can be saved, and the operation efficiency of the UAV can be improved.

The present disclosure further provides a computer readable storage medium. FIG. 7 is a schematic diagram of an example computer readable storage medium consistent with the disclosure. The computer readable storage medium stores executable instructions that, when being executed by one or more processors, cause the one or more processors to execute a method consistent with the disclosure, such as one of the above-described example methods. For example, the instructions can cause the one or more processors to execute the following operations.

The work region and the operation points of the work region can be obtained. The work region can be divided into the plurality of operation regions, and the ports of the plurality of operation regions can be obtained, and the waypoints of the work region can include the operation points and the ports. The constraint conditions can be imposed on the waypoints to obtain the minimized no-operation route.

For the flow chart of the route planning method in FIG. 4, some blocks or combinations of blocks in the flow chart can be implemented by the executable instructions. These executable program instructions can be provided to the processors of the general purpose computers, special purpose computers, or other programmable data processing devices.

Therefore, the route planning method consistent with the present disclosure can be implemented by hardware, software, or a combination thereof. The disclosed embodiments may use the form of a computer-readable storage medium storing executable instructions, and the computer-readable storage medium may be used by an instruction execution system (e.g., one or more processors) or used in conjunction with the instruction execution system. Herein, the computer-readable storage medium may include any medium that can contain, store, transmit, propagate, or transmit the instructions. For example, the computer-readable storage medium may include, but is not limited to, an electrical, magnetic, optical, electromagnetic, infrared, or semiconductor system, apparatus, device, or propagation medium. The computer-readable storage medium can include, for example, a magnetic storage device, e.g., a magnetic tape or a hard disk (HDD), an optical storage device, e.g., an optical disk (CD-ROM), a memory, e.g., a random access memory (RAM) or a flash memory, and/or a wired/wireless communication link.

Consistent with the disclosure, through obtaining the minimized no-operation route, the flight mileage and flight time of the UAV can be reduced, the power of the UAV can be saved, and the operation efficiency of the UAV can be improved.

The present disclosure further provides an operation carrier including the route planning device consistent with the disclosure. The operation carrier can include any UAV or unmanned vehicle that can perform an operation.

The present disclosure further provides a controller of the operation carrier including the route planning device consistent with the disclosure.

It can be appreciated by those skilled in the art that, for simplifying and conciseness of the description, the division of the functional modules described above is merely an example for illustration. In practical applications, the functions described above can be allocated to different functional modules as required. That is, an internal structure of the device can be divided into different functional modules to complete some or all of the functions described above. The working processes of the device described above are similar to the corresponding processes of the method described above, and detailed description thereof will be omitted herein.

It is intended the disclosed embodiments be considered as exemplary only and not to limit the scope of the disclosure. Although the present disclosure has been described in detail with reference to the disclosed embodiments, it can be appreciated by those of ordinary skill in the art that the technical solutions described in the embodiments can be modified, or some or all of the technical features can be equivalently replaced. Unless being conflicted, the features in different embodiments can be combined. Changes, modifications, alterations, and variations of the above-described embodiments may be made by those skilled in the art within the scope of the disclosure.

What is claimed is:

1. A route planning method comprising:
obtaining a work region and operation points of the work region;
dividing the work region into a plurality of operation regions;
obtaining ports of the plurality of operation regions; and
imposing one or more constraint conditions on waypoints of the work region to obtain a minimized no-operation route, the waypoints including the operation points and the ports.

2. The method of claim 1, wherein obtaining the work region includes:
obtaining position information of a boundary of the work region.

3. The method of claim 2, wherein dividing the work region into the plurality of operation regions includes:
obtaining a plurality of route segments parallel to each other in the work region; and
obtaining the plurality of operation regions according to directions of the route segments and the position information of the boundary of the work region.

4. The method of claim 3, wherein obtaining the ports of the plurality of operation regions includes, for an operation region of the plurality of operation regions:
determining endpoints of two outermost route segments in the operation region as the ports of the operation region.

5. The method of claim 4, wherein determining the endpoints of the two outermost route segments in the operation region as the ports of the operation region includes:
in response to a number of route segments in the operation region being odd, pairing two ports on opposite sides of the two outermost route segments; or
in response to a number of route segments in the operation region being even, pairing two ports on a same side of the two outermost route segments.

6. The method of claim 1, wherein:
the operation points of the work region include an origin point; and
the one or more constraint conditions include:
a plurality of first constraint conditions including that:
a length of the minimized no-operation route passing through the origin point and the ports of the plurality of operation regions is smallest;
one route exists between each of two ports of each of the plurality of operation regions and each of other waypoints;
two ports paired with each other in each of the plurality of operation regions have equal number of routes with the other waypoints; and
two routes exist between the origin point and the ports of the plurality of operation regions; and
a second constraint condition including that some waypoints on the minimized no-operation route do not form a sub-loop.

7. The method of claim 6, wherein:
the operation points of the work region further include a relay point; and
the plurality of first constraint conditions further include that two routes are formed between the relay point and the other waypoints.

8. The method of claim 6, wherein the other waypoints with respect to a current operation region includes the operation points and the ports of one or more operation regions adjacent to the current operation region.

9. The method of claim 6, wherein imposing the one or more constraint conditions on the waypoints of the work region to obtain the minimized no-operation route includes:
solving objective functions under the one or more first constraint conditions for a candidate no-operation route;
determining whether the candidate no-operation route satisfies the second constraint condition;
in response to the candidate no-operation route satisfying the second constraint condition, determining that the candidate no-operation route as the minimized no-operation route; and
in response to the candidate no-operation route not satisfying the second constraint condition, applying the second constraint condition to the candidate no-operation route to obtain a new candidate no-operation route, and determining whether the new candidate no-operation route satisfies the second constraint condition.

10. The method of claim 9, wherein solving the objective functions for the candidate no-operation route includes using an integer linear programming (ILP) method to solve the objective functions.

11. The method of claim 1, wherein:
the operation points of the work region include a start point and an end point; and
the one or more constraint conditions include:
a plurality of first constraint conditions including that:
a length of the minimized no-operation route passing through the start point, the end point, and the ports of the plurality of operation regions is smallest;
one route exists between each of two ports of each of the plurality of operation regions and each of other waypoints;
two ports paired with each other in each of the plurality of operation regions have equal number of routes with the other waypoints; and
one route exists between each of the start point and the end point and the ports of the plurality of operation regions; and
a second constraint condition including that some waypoints on the minimized no-operation route do not form a sub-loop.

12. The method of claim 1, wherein:
the minimized no-operation route goes through at least one of the operation points and the ports of at least one of the plurality of operation regions.

13. A route planning device comprising:
a memory storing executable instructions; and
a processor configured to execute the executable instructions stored in the memory to:
obtain a work region and operation points of the work region;
divide the work region into a plurality of operation regions;
obtain ports of the plurality of operation regions; and
impose one or more constraint conditions on waypoints of the work region to obtain a minimized no-operation route, the waypoints including the operation points and the ports.

14. The device of claim 13, wherein the processor is further configured to execute the executable instructions to:
obtain position information of a boundary of the work region.

15. The device of claim 14, wherein the processor is further configured to execute the executable instructions to:
obtain a plurality of route segments parallel to each other in the work region; and
obtain the plurality of operation regions according to directions of the route segments and the position information of the boundary of the work region.

16. The device of claim 15, wherein the processor is further configured to execute the executable instructions to, for an operation region of the plurality operation region:
determine endpoints of two outermost route segments in the operation region as the ports of the operation region.

17. The device of claim 13, wherein:
the operation points of the work region include an origin point; and
the one or more constraint conditions include:
a plurality of first constraint conditions including that:
a length of the minimized no-operation route passing through the origin point and the ports of the plurality of operation regions is smallest;
one route exists between each of two ports of each of the plurality of operation regions and each of other waypoints;
two ports paired with each other in each of the plurality of operation regions have equal number of routes with the other waypoints; and
two routes exist between the origin point and the ports of the plurality of operation regions; and
a second constraint condition including that some waypoints on the minimized no-operation route do not form a sub-loop.

18. The device of claim 17, wherein:
the operation points of the work region further include a relay point; and
the plurality of first constraint conditions further include that two routes are formed between the relay point and the other waypoints.

19. The device of claim 13, wherein:
the operation points of the work region include a start point and an end point; and
the one or more constraint conditions include:
a plurality of first constraint conditions including that:
a length of the minimized no-operation route passing through the start point, the end point, and the ports of the plurality of operation regions is smallest;
one route exists between each of two ports of each of the plurality of operation regions and each of other waypoints;
two ports paired with each other in each of the plurality of operation regions have equal number of routes with the other waypoints; and
one route exists between each of the start point and the end point and the ports of the plurality of operation regions; and
a second constraint condition including that some waypoints on the minimized no-operation route do not form a sub-loop.

20. An operation carrier comprising:
a route planning device including:
a memory storing executable instructions; and
a processor configured to execute the executable instructions stored in the memory to:
obtain a work region and operation points of the work region;
divide the work region into a plurality of operation regions;
obtain ports of the plurality of operation regions; and
impose one or more constraint conditions on waypoints of the work region to obtain a minimized no-operation route, the waypoints including the operation points and the ports.
